(19) United States
(12) Patent Application Publication
(10) Pub. No.: US 2007/0138071 A1
(43) Pub. Date: Jun. 21, 2007

(54) Water distribution system

(76) Inventor: Keith Froggatt, Ashbourne (GB)

Correspondence Address: BUCHANAN, INGERSOLL & ROONEY PC, POST OFFICE BOX 1404, ALEXANDRIA, VA, 22313-1404, US

(21) Appl. No.: 10/578,890

(22) PCT Filed: Nov. 8, 2004
(86) PCT No.: PCT/GB04/04715

§ 371 Date: Jan. 18, 2007

(30) Foreign Application Priority Data
Nov. 11, 2003 (GB) 0326208.6
Nov. 18, 2003 (GB) 0326820.8

(51) Int. Cl. B01D 29/00

(52) U.S. Cl. 210/153

(57) ABSTRACT

A shower arrangement including a plurality of freely movable silver coated decontaminating members in the shower head. Inserts of a decontaminating material such as silver are provided at each end of an upper section of the stand pipe, with the decontaminating members and inserts substantially preventing build up of bacteria.

This invention concerns improvements in or relating to water distribution systems, particularly but not exclusively shower head assemblies, and particularly but not exclusively calorifiers.

Problems can be encountered in water systems where water stands for a significant time. Bacteria and especially legionella may grow and multiply in such water as it stagnates, and particularly if the water has been warmed. Showers can present a particular danger in this regard, in that water from a shower can be breathed in and/or ingested. In establishments such as hotels, hospitals or workplaces, showers may not be used for some time, and thus a build up of bacteria could occur.

Calorifiers are used to heat water, and may be provided in domestic, institutional or commercial situations. A calorifier may include an electric heater, or for instance a boiler where hot fluid is passed through pipe work extending through a water tank or similar. Problems can be encountered in calorifiers where water stands for a significant time. Bacteria and especially legionella may grow and multiply in such water as it stagnates, and particularly if the water has been warmed.

Other instances where a build up of bacteria can occur are pipes where there may be no water flow for some time. This could include hose pipes and also fire sprinkler systems, as well as plant watering systems which may not be used during certain times of the year such as winter.

According to the present invention there is provided a water distribution system, the system including one or more circulation members through which water can pass, and one or more decontaminating members restrainably located within the body and freely movable therein, the or each decontaminating member having an outer surface of an antibacterial material.

The system is preferably arranged such that when no water is passing therethrough the decontaminating member or members will locate in a lowermost part or parts of the member or members.

The antibacterial material may comprise silver or a silver compound.

The decontaminating member or members may have a coating of antibacterial material. The decontaminating member or members may be any of spherical, oval, cuboidal, or be in the form of lengths of strip. The decontaminating member or members may have a contoured surface, which may include projections which may be in the form of spikes.

The decontaminating member or members may be formed from material in the form of a mesh, which may be formed into a required shape.

The decontaminating member or members may be made of any of copper, steel, plastics material or silver.

The decontaminating member or members may be solid or hollow. One or more passages may be provided through the decontaminating member or members, with the surfaces of the passages being formed by an antibacterial material.

Some of the decontaminating members may sink in water.

Some of the decontaminating members may float in water, and said decontaminating members may include a portion of a material which is less dense that water. A mixture of decontaminating members which respectively either float or sink in water may be provided.

Filter means may be provided at an upstream part and/or downstream part of the circulation member to prevent the decontaminating member or members passing out of the circulation member. The filter means may be coated or made from antibacterial material. The filter means may be substantially planar, generally spherical or perhaps generally frusto conical.

The filter means may be formed of a mesh material, and may be in the form of a body of mesh material, which body may provide a friction fit in the circulation member. One or more decontaminating members may be restrainably located in the body.

The circulation member may be in the form of a shower head assembly including a hollow body through which water passes in use.

The shower head assembly may include a spray member defining a plurality of outlets through which water passes to provide a spray, and the spray member may have an outer surface of an antibacterial material.

The spray member may be coated with an antibacterial material or made of an antibacterial material.

The hollow body may be made of plastics material.

At least a lower part in use of the hollow body may be provided with a layer of antibacterial material. The layer may be provided by an insert located in the hollow body. Alternatively the layer may be provided by a coating of antibacterial material on the interior of the hollow body.

In an alternative arrangement the circulation member may be in the form of a calorifier including a receptacle for water to be heated, with the decontaminating member or members restrainably located within the receptacle.

The calorifier is preferably arranged such that the decontaminating member or members will generally locate in a lowermost part or parts of the receptacle.

A drain is preferably provided towards the lower part of the receptacle, with filter means to prevent the decontaminating member or members from passing through the drain.

At least the part of the drain which extends into the receptacle may have an outer surface of antibacterial material.

A coating of antibacterial material may be provided on the inner surface of a lower part of the receptacle.

Embodiments of the present invention will now be described by way of example only and with reference to the accompanying drawings in which:

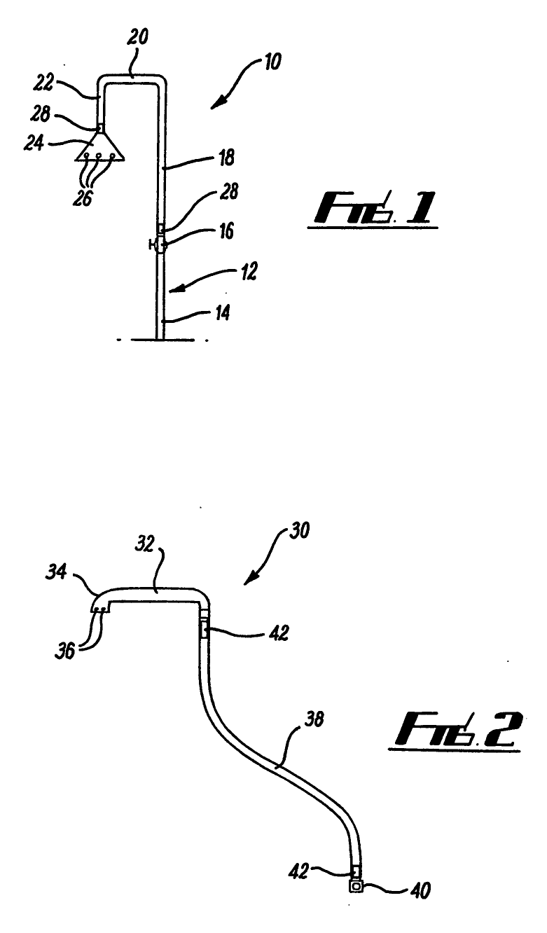

FIG. 1 is a diagrammatic side view of a first shower arrangement according to the invention;

FIG. 2 is a diagrammatic side view of part of a second shower arrangement according to the invention;

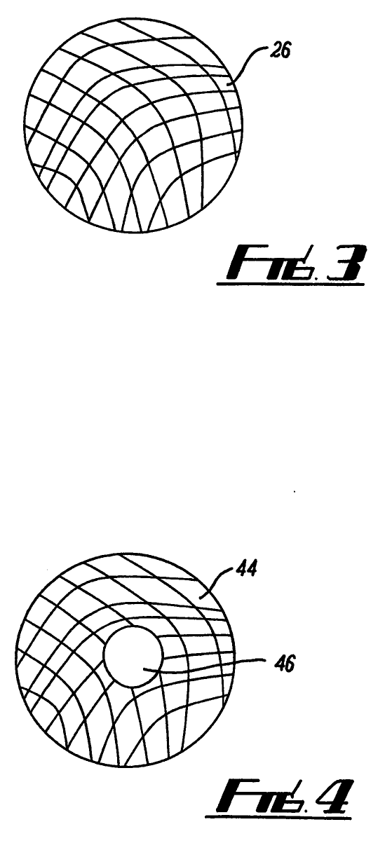

FIGS. 3 and 4 are side views of components usable in arrangements according to the invention;

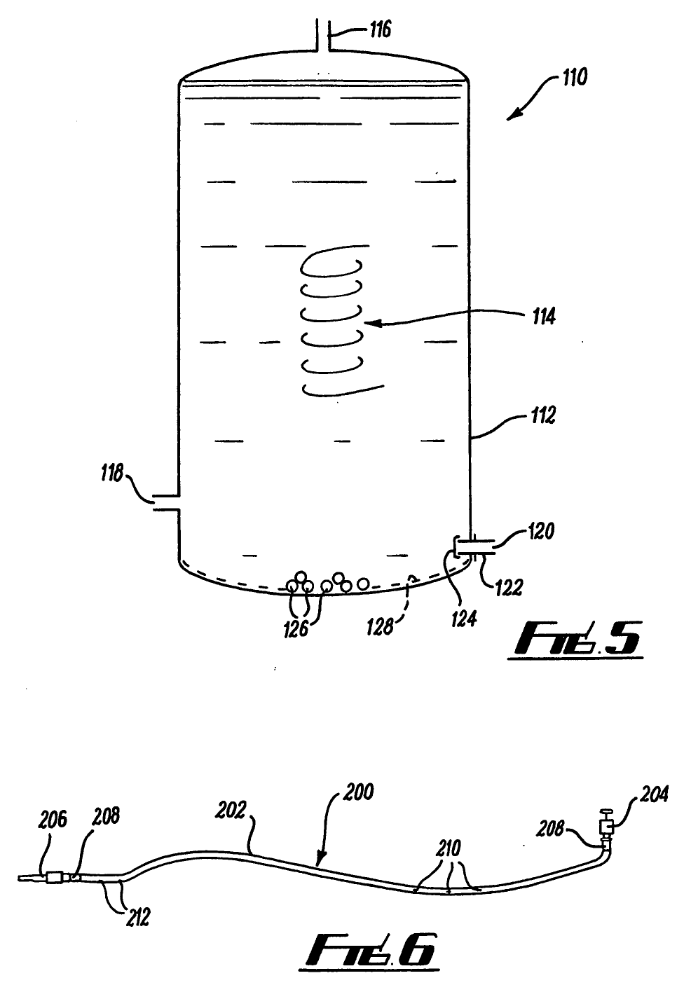

FIG. 5 is a diagrammatic cross sectional view through a calorifier according to the invention; and

FIG. 6 is a diagrammatic side view of a hose pipe arrangement according to the present invention.

FIG. 1 shows a first shower arrangement with a stand pipe 12 with a lower section 14 leading to a control valve 16. An upper section 18 extends from the control valve 16 vertically upwards to a lateral portion 20, which portion 20 connects to a downwardly extending part 22 leading into a shower head 24. The shower head 24 has a generally downwards facing conical shape. Located in the head 24 are a plurality of decontaminating members 26 of the type shown in FIG. 3.

The decontaminating members 20 are in the form of spheres of a silver coated mesh material. Inserts 28 are provided at the downstream end of the down part 22 and the upstream end of the upper section 18. The inserts 28 are cylindrical and made of a silver coated mesh material through which water can flow, and provide a friction fit in the required position. If required one or more decontaminating members 26 could be restrainably located within the inserts 28. If required, one or more decontaminating members could be located in the pipe 12 between the inserts 28.

In use, water will pass through the control valve 16 through the upper section 18, lateral portion 20 and down part 22, and out through the shower head 24. In doing this the water will pass through the inserts 28 and over the decontaminating members 26. When the shower is turned off water will tend to gather at the lower end of the upper section 18 and also in the head 24. The respective insert 28 and decontaminating members 26 will substantially prevent growth of bacteria in any such stagnant water.

FIG. 2 shows part of a second shower arrangement 30. In this instance a plastics material shower head 32 is provided with an outlet portion 34. Decontaminating members 36 are located in the shower head 32, and will tend to locate in the portion 34 when the arrangement 30 is not in use. A flexible pipe 38 extends from the head 32 to a control valve 40. Inserts 42 of a silver coated mesh material are provided at each end of the pipe 38. The arrangement 30 will operate in a similar manner to the arrangement 10 with the decontaminating members 36 and inserts 42 substantially preventing bacteria build up in any water remaining in the arrangement 30.

There are thus described shower arrangements which substantially prevent the growth of bacteria, even if the arrangements are not used for some time. Providing the freely movable decontaminating members means that irrespective of the orientation of the respective shower head, the decontaminating members will tend to locate in the lowermost part or parts thereof which is where any residual water will gather. The respective inserts also help to prevent the growth of bacteria in any water remaining in the pipes leading to the shower heads.

Various modifications may be made without departing from the scope of the invention. For instance, a different antibacterial material may be provided on the decontaminating members and/or inserts. Such a material may be a silver compound. The inserts may take different forms, and could be replaced by filters of a wide range of different shapes.

The decontaminating members may take a number of different shapes. As well as being spherical or oval, they could be cuboidal or could include lengths of strip. The surface of the decontaminating members may be contoured, and could include projections which may be in the form of spikes.

The decontaminating members may be formed so as to sink, or in some instances float. FIG. 4 shows a decontaminating member 44 of a mesh material with a silver coating, and a core 46. The core is of a light material which is significantly less dense than water, and causes the decontaminating member 44 to float in water. It may be advantageous to provide a mixture of floating and non floating contaminating members. The floating contaminating members will tend to follow the water, and thereby rest in any remaining water at the end of the waterflow.

The decontaminating members may have a coating of antibacterial material and could be formed from copper, steel or plastics material. Alternatively, it may be possible to use solid antibacterial material. The decontaminating members may be solid or hollow, and one or more passages may be provided therethrough with the surfaces of the passages being formed by an antibacterial material. With this arrangement this would ensure that some antibacterial material remains, even where coatings on the decontaminating members may eventually be abraded away.

Part of the shower heads may be provided by antibacterial material. For instance a coating may be provided on a spray member of the shower head, or this part of the shower head could be made of antibacterial material. An interior layer of part of the shower head could be provided with the coating of antibacterial material, and this may be provided by an insert in for instance a plastics material shower head.

FIG. 5 of the drawings shows a calorifier 110 including a receptacle in the form of a tank 112. A heating element 114 is provided to heat water within the tank 112. It is to be realised that other heating means for the water could be used, such as a boiler supplying heated fluid to pass through a coil or other structure of pipe work in the tank 112.

An outlet 116 for heated water is provided towards the top of the tank 112. An inlet 118 is provided towards the lower part of the tank 112 and is connected to a cold water feed (not shown). A drain 120 is provided in a still lower part of the tank 112. The drain 120 includes a pipe 122 which is threadably mounted on the tank 112, and at least the part of the pipe 122 which extends into the tank 112 may be provided with an antibacterial coating of, for instance silver. A filter 124 is provided over the inner end of the pipe 122, and the filter 124 is also made of an antibacterial material such as silver.

A plurality of decontaminating members in the form of silver coated, generally spherical members 126 are provided in the tank 112 so as to be freely movable therein. The decontaminating members 126 have a plurality of passages extending therethrough which also have a lining of decontaminating material. A coating of decontaminating material could also be provided on the inner surface of a lower part of the tank 112, as shown by the broken line 128.

In use, the decontaminating members 126 will locate by gravity towards the lowest part of the tank 112, thereby remaining in contact with water in the tank, even if this is at a very low level. The filter 124 prevents the decontaminating members 126 passing therethrough, even during emptying or flushing of the tank 112.

There is thus provided a relatively straightforward arrangement and method for preventing build up of bacteria in calorifiers. For existing tanks, the arrangement could readily be retro fitted, with the decontaminating members 126 located in a conventional tank, and an appropriate filter being provided over the drain.

FIG. 6 shows a hose pipe arrangement 200 according to the invention the arrangement 200 includes a hose pipe 202 leading from a tap 204. An adjustable nozzle 206 is provided on the far end of the hose pipe 202. Inserts 208 formed of cylindrical blocks of silver coated mesh material are provided in the hose pipe 202 respectively adjacent the fitting to the tap 204 and the nozzle 206.

A plurality of decontaminating members are provided in the hose pipe 202. A first type 210 of decontaminating member is as shown in FIG. 3, and sinks in water. Some decontaminating members of a second type 212 are provided which are similar to that shown in FIG. 4, and float in water. This means that the first type 210 will tend to move to the lowest part of the hose pipe 202, whilst the second type 212 will tend to move towards the nozzle 206, with each of the decontaminating member types 210, 212 tending to locate at any stagnant water in the pipe 202.

There are thus described a number of water distribution systems including decontaminating members to help prevent the build up of bacteria. It is to be realized that a wide range of other modifications can be made, and any of the above described features can be combined as required.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-39. (canceled)

40. A water distribution system, including one or more circulation members, such as a shower assembly through which water can pass, wherein one or more decontaminating members are restrainably located within the or each circulating member and freely movable therein, the or each decontaminating member having an outer surface of an antibacterial material.

41. A system according to claim 40, wherein the system is arranged such that when no water is passing therethrough the decontaminating member or members will locate in a lowermost part or parts of the circulation member or members.

42. A system according to claim:40, wherein the decontaminating member or members have a contoured surface, which may include projections which may be in the form of spikes.

43. A system according to claim 40, wherein the decontaminating member or members are in the form of a mesh.

44. A system according to claim 40, wherein one or more passages are provided through the decontaminating member or members, with the or each surface of the or each passage being formed by an antibacterial material.

45. A system according to claim 40, wherein the system comprises a plurality of decontaminating members, a mixture of decontaminating members which respectively either float or sink in water.

46. A system according to claim 40, wherein filter means are provided at an upstream part and/or downstream part of the or each circulation member to prevent the decontaminating member or members passing out of the circulation member.

47. A system according to claim 46, wherein the filter means are coated or made from antibacterial material.

48. A system according to claim 46, wherein the filter means are in the form of a body of mesh material.

49. A system according to claim 48, wherein a body of mesh material provides a friction fit in the circulation member.

50. A system according to claim 40, wherein the circulation member is in the form of a shower head assembly including a hollow body through which water passes in use.

51. A system according to claim 50, wherein the shower head assembly includes a spray member defining a plurality of outlets through which water passes to provide a spray, and the spray member has an outer surface of an antibacterial material.

52. A system according to claim 51, wherein at least a lower part in use of the hollow body is provided with a layer of antibacterial material.

53. A system according to claim 40, wherein the circulation member is in the form of a calorifier including a receptacle for water to be heated and the decontaminating member or members is/are restrainably located within the receptacle.

54. A system according to claim 53, wherein the calorifier is arranged such that the decontaminating member or members will generally locate in a lowermost part or parts of the receptacle.

55. A system according to claim 53, wherein a drain is provided towards the lower part of the receptacle, with filter means to prevent the decontaminating member or members from passing through the drain.

56. A system according to claim 55, wherein at least the part of the drain which extends into the receptacle has an outer surface of antibacterial material.

57. A system according to claim 53, wherein a coating of antibacterial material is provided on the inner surface of a lower part of the receptacle.

58. A shower arrangement comprising a shower head and one or more silver coated decontaminating members in- the shower head arranged at or adjacent the exit of the shower head, the plurality of freely movable silver coated decontaminating members being freely movable.

59. A shower arrangement according to claim 58, which is designed to retain its shape through use.
